(19) United States
(12) Patent Application Publication
(10) Pub. No.: US 2026/0145535 A1
(43) Pub. Date: May 28, 2026

(54) E-BIKE BATTERY SYSTEM AND E-BIKE

(71) Applicant: Porsche eBike Performance GmbH, Ottobrunn (DE)

(72) Inventors: Anton Kanyshev, Zagreb (HR); Mislav Lovric, Zagreb (HR)

(21) Appl. No.: 19/395,973

(22) Filed: Nov. 20, 2025

(30) Foreign Application Priority Data
Nov. 25, 2024 (DE) 102024134638.8

(51) Int. Cl. B60L 3/00; B60L 50/64

(52) U.S. Cl. CPC B60L 3/0046; B60L 50/64; B60L 2200/12; B60L 2250/16

(57) ABSTRACT

In an embodiment an e-bike battery system includes at least one battery cell and a connector, wherein the connector and the at least one battery cell are interconnected via a power line, a first sensor configured for detecting state values of the at least one battery cell, a controller connected to the first sensor and configured to receive and evaluate the state values of the first sensor, and a switch arranged in the power line and configured for selectively establishing a connection between the connector and the at least one battery cell, wherein the controller is connected to the switch and is configured to send a control signal to the switch for switching the switch.

### CROSS-REFERENCE TO RELATED APPLICATIONS

This application claims priority to German patent application no. 10 2024 134 638.8, filed on Nov. 25, 2024, which application is hereby incorporated herein by reference.

### TECHNICAL FIELD

The invention relates to an e-bike battery system. The invention further relates to an e-bike having an e-bike battery system of this kind and to a method for controlling an e-bike battery system.

### BACKGROUND

Bicycles with an electrically assisted drive—also referred to as e-bikes or pedelecs—are now widespread and well known. Such e-bikes generally comprise a drive unit, in particular an electric motor. The electric motor is supplied with energy by at least one battery cell and usually via an entire battery pack having a plurality of battery cells. A battery pack in this case comprises a housing in which one or more battery cells are arranged. A plurality of battery cells is usually combined to form a battery module and is interconnected within the battery module.

The battery pack also typically comprises a battery management system (BMS). The BMS is used, among other things, to monitor the voltage, current and temperature of the battery cells, to control the load and the charging of the battery cells and to balance the battery cells. The BMS is furthermore usually connected to a connector via which the battery pack can be charged or discharged.

The drive unit is to be supplied by the battery module with the highest possible currents and power. A limiting factor for the flow of high currents and the provision of high power is that the components of the BMS must not be heated beyond their specified temperature. Conventional BMS components are often only designed for temperatures up to 85° C.

### SUMMARY

Embodiments of the invention provide an e-bike battery system, an e-bike having an e-bike battery system of this kind, and a method for controlling an e-bike battery system by means of which high voltages and powers can be transferred to and from the battery cells, and which is also suitable for higher temperatures.

An e-bike battery system according to the embodiments of the invention comprises at least one battery cell which is connected to a connector via a power line.

In particular, the e-bike battery system comprises a plurality of battery cells which are combined to form a battery pack. The individual battery cells are electrically interconnected. The e-bike battery system comprises, in particular, a plurality of battery cells, specifically between 20 and 35 battery cells, e.g., 24 or 33 battery cells at 3.6 V each. The battery cells are, in particular, connected in an 11s3p, 12s2p or 13s1p configuration. In an 11s3p configuration, 11 cells are wired in series across 3 parallel strings. In a 12s2p configuration, 12 cells in each case are arranged in series in two parallel strings (12s2p). The arrangement of the battery cells in the 12s2p configuration is, in particular, in two layers, each having two rows of battery cells of 4 batteries each. The battery cells are particularly cylindrical in design. Overall, the battery cells can provide a supply voltage in the low-voltage range. The nominal voltage of the battery module is in particular below 60 V and is, for example, between 35 V and 45 V, or between 39.6 V or 43 V.

Via the power line, the power provided by the battery cells is transferred to the at least one connector (discharge mode) or, for charging the battery cells, a charging power is transferred from the connector to the at least one battery cell (charge mode).

The battery cell(s) can be charged or discharged via the connector of the e-bike battery system. In other words, energy can be supplied via the connector, for example from a charging plug, to the at least one battery cell. Via the connector, the at least one battery cell can be connected to a load, in this case to an electric motor to provide assistance power and supply it with energy. Overall, the connector forms the interface between the battery cells and the entire e-bike battery system, on the one hand, and the charging system and/or the motor control and electronics system, on the other hand.

A switch is arranged in the power line, wherein the switch is configured to selectively establish a connection between the connector and the at least one battery cell. The switch comprises, in particular, two sets of MOSFETs which, in a manner known in the art, connect the at least one battery cell to the connector in such a manner that the battery cells can either be charged or discharged (charge or discharge mode), or in such a manner that a connection between the connector and the battery cells is interrupted (safe state), or a pre-discharge mode or pre-charge mode is implemented. In the pre-discharge or pre-charge mode, the cells are discharged or charged with limited current or limited energy, using MOSFETs with a current limiting circuit or MOSFETs with PWM control.

Furthermore, the e-bike battery system comprises a sensor for detecting the state values of the battery cells. A sensor of this kind may, in particular, be a battery monitoring integrated chip (BMIC). A BMIC for monitoring battery cells is an integrated circuit specially configured to continuously monitor and control the performance parameters and state of the battery cells, particularly the state of groups of parallel-connected battery cells, within a battery pack. The BMIC detects the state values of the battery cells in this case, such as the cell voltage, temperature and state of charge of the battery cells, in order to ensure safe and efficient operation of the battery cells. A BMIC may also have functions for cell balancing, over-voltage and under-voltage protection, over-current protection and temperature management, in order to extend the service life of the battery cells and minimize the risk of malfunctions or damage. A BMIC is, in particular, a standard component.

In addition, the e-bike battery management system comprises a controller which is connected to the sensor and is configured to receive and evaluate the detected state values of the sensor. Evaluating the state values means, in particular, that the controller is configured to compare the received state values with defined limit values and to detect any exceeding or falling below of the respective limit value. The controller is in particular a microcontroller. For example, the controller comprises a memory, in particular a NOR-flash memory, especially for storing detected state values.

According to embodiments of the invention, the controller is connected to the switch and is configured to send a control signal to the switch for switching the switch. That is, on the basis of the control signal, the switch is prompted to assume a state in which either charging or discharging of the battery cells is possible, or the battery cells are brought into a safe state in which the connector and the battery cells are electrically isolated from one another.

The combination of the sensor and the controller can also be referred to as a battery management system, which connects the at least one battery cell to other parts of the e-bike system in a controlled and safe manner.

In the architecture of the proposed e-bike battery system, the sensor may be a pure detection and measurement unit, and the controller is the logical or control unit that switches the switch as required. The controller is configured to collect all information needed from the sensor or other units, in order to make a safety-relevant decision and to send the necessary control signal to the switch. Owing to the purely sensing function of the sensor, a standard component can be used in this case that is suitable for higher temperatures of up to 125° C.

Overall, the e-bike battery system is provided as a compact unit, wherein, in particular, all electronic components apart from the battery cells are arranged on a printed circuit board.

Overall, by separating the sensor from the controller that provides the control function via the switch, components with a higher temperature specification can be used and, as a consequence, power levels of up to 1,200 W peak power or 950 W continuous power can be transmitted over the power line.

In particular, the controller is connected to a high-side switch for switching the switch. The controller is configured to send one or more control signals to the high-side switch, and the high-side switch provides the voltage required to actuate the switch, in particular the two sets of MOSFETs. The high-side switch can accordingly also be referred to as an actuator. The high-side switch is an electronic circuit component capable of controlling the current flow from the positive supply (high side) of the battery cell to the connector. In particular, the high-side switch provides galvanic isolation between the controller and the switch.

In a further practical embodiment of the e-bike battery system, the controller is also connected to at least one further sensor. An advantage of the present circuit architecture connecting the controller to the switch instead of the BMIC to the switch is that the controller can also process additional sensor signals, in addition to the signals from the sensor, and can thereby provide more information that improves the performance of the e-bike battery system and also enhances the safety of the e-bike battery arrangement.

In particular, the controller is connected to at least one humidity sensor. In this case, a humidity sensor may be a sensor that measures the humidity in the region of the battery cells, for example in the housing of a battery module, and/or a humidity sensor may detect the humidity in the region of the electronics of the sensor or the controller. If, for example, excessive humidity is detected in the region of the battery cells or in the region of the electronics of the controller, a connection between the connector and the battery cells can be interrupted (safe state).

Alternatively, or in addition, the controller can be connected to a further sensor in the form of a voltmeter. The voltmeter is, in particular, configured to detect a voltage drop across the switch. The controller can compare the voltage thereby detected with the expected voltage on the basis of the control commands sent by the controller to the switch and, where appropriate, detect a fault or defect in the switch and trigger a safe state accordingly.

In particular, the controller is connected to a fuse in the power line and is configured to control and monitor the fuse. In the event of an excessive current flow in the power line, the fuse can be activated or tripped by the controller, so that the connection between the connector and the at least one battery cell is interrupted, at least for a defined time interval. For this purpose, the controller monitors a defined current-time characteristic in the power line and, when this characteristic is exceeded (i.e. when an excessively high current flows for a given time interval), the fuse is activated or tripped. The fuse is, in particular, a non-resettable fuse.

Alternatively, or in addition, a second fuse may be arranged in the power line, in particular a short-circuit fuse, e.g. a cartridge fuse, by means of which, independently of the controller, the connection between the connector and the at least one battery cell can be interrupted. The short-circuit fuse interrupts the connection in the power line in a manner known per se when a predefined current-voltage characteristic for an e-bike is exceeded. When this fuse trips, the connection between the connector and the battery cells is permanently interrupted and the e-bike battery system only becomes functional again after the fuse has been replaced.

In a further practical embodiment, the controller is connected to the connector via a communications bus. Diagnostic information from the MCU can therefore be transmitted via the connector and, conversely, updates or bug-fix software, for example, can be loaded onto the MCU via the connector. The communications bus is, in particular, a CAN bus.

It can also be provided that the controller is connected to a human- machine interface (HMI). The HMI in this case may be a display or one or more optical elements (in particular LEDs) and/or a loudspeaker for generating sounds. In this way, a state of the e-bike battery system and/or of the battery cells can be communicated to a user via the HMI by means of the controller.

The HMI may, in addition, comprise an actuating device, such as a push-button, by means of which the e-bike battery system can be placed, in particular, in a deactivated mode or an activated mode. In particular, the controller is functionally connected to the actuating device.

In a further practical embodiment of the e-bike battery system, a shunt resistor is arranged in the power line. In a battery management system, a shunt resistor is a precise, low-ohmic resistor connected in series to the current path of the battery cells, in order to measure the current flowing through the battery cells. By generating a small, but measurable, voltage proportional to the current flow, the shunt resistor enables precise monitoring of the charge and discharge current. The voltage drop across the shunt resistor is measurable by means of the sensor and the measured value is supplied to the controller by the sensor.

In particular, the shunt resistor is functionally connected to a safety current limiter. The circuit of the safety current limiter is, in particular, a further sensor which provides the controller, as a redundant information source, with the output current of the battery cells. The safety current limiter is connected to the controller and reports to it whether, for example, an overcurrent or a short circuit is present, on the basis of which the controller can generate a control signal. The safety current limiter can be configured for this purpose to send a control signal directly to the switch or the high-side switch, in order to achieve a higher response speed.

An embodiment of the invention also relates to an e-bike with an e-bike battery system as described above. For this purpose, the e-bike comprises the e-bike battery system and a drive unit which is connected to the e-bike battery system and the battery cells present therein.

An embodiment of the invention also relates to a method for controlling an e-bike battery system with at least one battery cell, in particular an e-bike battery system as described above, wherein state values of the at least one battery cell are transmitted from a sensor to a controller. Based on the state values, the controller establishes a connection between a connector and the at least one battery cell or interrupts the connection. The selective establishment of the connection is effected, in particular, via a switch arranged in a power line, to which the controller can send control signals. The controller is, in particular, responsible for the actuation and safety of the e-bike battery system.

### BRIEF DESCRIPTION OF THE DRAWINGS

Further practical embodiments and advantages are described below in connection with the figures. In the drawings:

FIG. 1 shows a block diagram of an e-bike battery system and

FIG. 2 shows a more detailed block diagram of an e-bike battery system according to FIG. 1.

### DETAILED DESCRIPTION OF ILLUSTRATIVE EMBODIMENTS

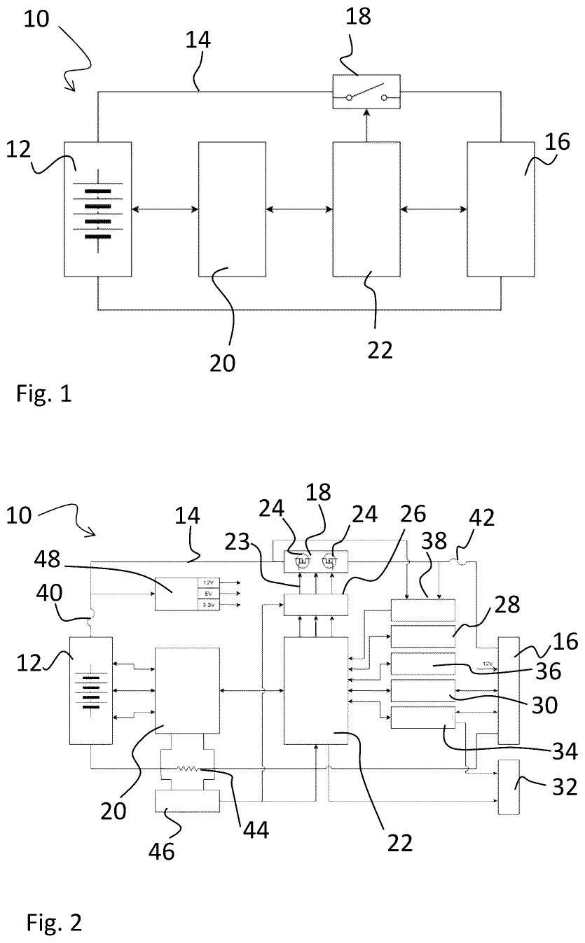

FIG. 1 shows a schematic block diagram of an e-bike battery system 10. The e-bike battery system 10 comprises a plurality of battery cells 12 which are connected to a connector 16 via a power line 14.

A switch 18 is arranged in the power line 14, which connects the connector 16 and the battery cells 12 to one another depending on the switching position.

The e-bike battery system 10 also comprises a sensor 20 which is connected to the battery cells 12. The sensor 20 may be a BMIC for detecting the state values of the battery cells 12. The sensor 20 detects, among other things, the state of charge and the temperature of the battery cells 12.

The sensor 20 is moreover connected to a controller 22. The controller 22 is configured to receive and evaluate the state data of the battery cells 12 detected by the sensor 20. The controller 22 is also connected to the connector 16 and can also receive signals from the connector 16 and transmit signals thereto.

The controller 22 is furthermore connected to the switch 18 and is configured to operate the switch 18 by means of control signals. Based on the state values and/or the signals originating from the connector 16, the controller 22 can output control signals and supply them to the switch 18

In accordance with the foregoing, the controller 22 constitutes the safety and logic unit of the e-bike battery system and the sensor 20 is implemented as a pure sensing unit.

FIG. 2 shows a detailed representation of the circuit diagram according to FIG. 1.

The e-bike battery system 10 comprises, as described in connection with FIG. 1, the plurality of battery cells 12, the connector 16 and the power line 14, as well as the sensor 20, the controller 22 and the switch 18.

In this case, the switch 18 is formed by two sets of MOSFETs 24 which, depending on the switching, can be brought into states in which charging/discharging of the battery cells 12 via the power line 14 takes place or in which the battery cells 12 are isolated from the connector 16 (safe state).

The controller 22 is connected to the switch 18 by means of a high-side switch 26. For this purpose, the controller 22 sends control signals 23 to the high-side switch 26, wherein the high-side switch 26 is configured to control the MOSFETs 24 so that they assume either a blocking state or a conducting state.

Furthermore, the controller 22 is also connected to a humidity sensor 28, wherein the humidity sensor 28 detects humidity in the region of the electronics of the e-bike battery system 10.

The controller 22 is to be connected to the connector 16 via a communications bus. The connection between the connector 16 and the controller 22 can be made wirelessly via a corresponding transceiver 30.

In addition, the controller 22 is connected to an HMI 32 (human-machine interface). Via the HMI 32, for example, a state of the battery cells 12, such as a state of charge, can be displayed and/or whether the e-bike battery system 10 is in a safe state or in an activated state.

The HMI 32 may comprise an actuating element (not shown), and the controller 22 can read the activation of the actuating element by means of a detector circuit 34 and, based thereon, for example, interrupt or establish the connection between the battery cells 12 and the connector 16.

The controller 22 can also be connected to a memory 36.

For checking the voltage drop across the switch 18, the controller 22 is connected to a voltmeter 38. The controller 22 can then compare the voltage drop determined by means of the voltmeter 38 with a target voltage drop set on the basis of the control signals 23.

As a safety element, the e-bike battery system 10 has, in the power line 14, a fuse 40. The controller 22 is functionally connected to the fuse 40 (connection not shown) and can activate the fuse 40 when a limit value is exceeded and thereby interrupt the connection between the connector 16 and the battery cells 12.

An additional safety element is a further fuse 42 in the power line 40, which can be activated independently from the controller 22 in this case. The fuse 40 is, in particular, a short-circuit fuse, such as a cartridge fuse, for example.

Connected in series with the battery cells 12 is a shunt resistor 44, which likewise serves to monitor the battery cells 12. The shunt resistor 44 is monitored by the sensor 22 and the measured values are transmitted to the controller 22.

The shunt resistor 44 is also connected to a safety current limiter 46. The circuit of the safety current limiter 46 acts as a secondary sensor which provides the controller 22, as a redundant information source, with the output current of the battery cells 12. The safety current limiter 46 is configured to notify the controller 22 when safety-relevant events occur (e.g. an overcurrent or a short circuit), so that the controller 22 can respond with a corresponding control signal. In the present case, the safety current limiter 46 is also configured to send a control signal directly to the high-side switch 26, in order to achieve a higher response speed.

Furthermore, the e-bike battery system 10 comprises a power management unit 48 for providing various supply voltages to the individual components present in the e-bike battery system 10. The power management unit 48 is, in particular, a PMIC.

What is claimed is:

1. An e-bike battery system comprising:
at least one battery cell and a connector, wherein the connector and the at least one battery cell are interconnected via a power line;
a first sensor configured for detecting state values of the at least one battery cell;
a controller connected to the first sensor and configured to receive and evaluate the state values of the first sensor; and
a switch arranged in the power line and configured for selectively establishing a connection between the connector and the at least one battery cell,
wherein the controller is connected to the switch and is configured to send a control signal to the switch for switching the switch.

2. The e-bike battery system according to claim 1,
wherein the controller is connected to a high-side switch, and
wherein the high-side switch is configured to receive the control signal from the controller and, based thereon, to actuate the switch.

3. The e-bike battery system according to claim 1, wherein the controller is connected to at least one second sensor.

4. The e-bike battery system according to claim 3, wherein the second sensor is at least one humidity sensor.

5. The e-bike battery system according to claim 3,
wherein the second sensor is a voltmeter, and
wherein the voltmeter is configured to measure a voltage drop across the switch.

6. The e-bike battery system according to claim 1, wherein the controller is connected to a fuse in the power line and is configured to control and monitor the fuse.

7. The e-bike battery system according to claim 1, further comprising a fuse arranged in the power line, wherein the fuse is trippable independently of the controller.

8. The e-bike battery system according to claim 1, wherein the controller is connected to the connector via a communications bus and/or the controller is connected to a human machine interface (HMI).

9. An E-bike comprising:
the e-bike battery system according to claim 1.

10. A method for controlling an e-bike battery system with at least one battery cell, the method comprising:
transmitting state values of the at least one battery cell from a sensor to a controller; and
establishing or disconnecting, by the controller, based on the state values, a connection between a connector and the at least one battery cell.
